(19) United States
(12) Patent Application Publication
(10) Pub. No.: US 2009/0173798 A1
(43) Pub. Date: Jul. 9, 2009

(54) Thermostatic Element, A Regulator Valve Including Such An Element And A Cooling Liquid Circuit Incorporating Such A Valve

(75) Inventor: Lionel Jean Mabboux, Sainte Genevieve Des Bois (FR)

Correspondence Address: Ralph A. Dowell of DOWELL & DOWELL P.C., 2111 Eisenhower Ave, Suite 406, Alexandria, VA, 22314, US

(73) Assignee: VERNET, Ollainville (FR)

(21) Appl. No.: 12/309,386

(22) PCT Filed: Jul. 19, 2007
(86) PCT No.: PCT/FR2007/001242

§ 371 Date: Jan. 16, 2009

(30) Foreign Application Priority Data
Jul. 20, 2006 (FR) 06 06613

(51) Int. Cl. G05D 23/02; F28D 15/00

(52) U.S. Cl. 236/93 R; 165/104.19

(57) ABSTRACT

The thermostatic element (36) includes a cup (38) and a piston (40) that is movable in translation along an axis under the effect of the expansion of a thermodilatable material contained in the cup. To limit the size of the valve incorporating this element, and also to improve its reliability and making it easier to assemble, the thermostatic element includes a sheath (42) for guiding the piston (40) in translation, which sheath is held stationary relative to the cup (38) and defines internally a fluid flow passage (46) having one end (48) directed towards the cup that is open transversely to the outside of the sheath and that is adapted to be connected to a fluid access, and a second end (54) remote from the cup that is open axially and be shut by a shutter (50) carried by the piston.

The present invention relates to a thermostatic element and to a thermostatic valve for regulating a fluid, in particular a cooling liquid, and including such an element. The invention also relates to a cooling liquid flow circuit, in particular for the cooling liquid of an engine, the circuit being associated with a heat exchanger through which said cooling liquid passes and through which there also passes a reference liquid, in particular oil for a gearbox associated with the engine.

FR-A-2 807 818 discloses a valve and a circuit of this type, in which the thermostatic element incorporated in the valve controls the admission of hot cooling liquid and/or of cold cooling liquid into a heat exchanger that is also fed by oil from a gearbox. Such regulation is advantageous, but as a general rule the valve for performing such regulation is complex in design and to assemble, because of the need to control movements in translation of the piston of the thermostatic element for determining the flow rates of the hot cooling liquid and of the cold cooling liquid that are admitted into the heat exchanger on the basis of a reference temperature that is associated with the gearbox oil. It is therefore necessary to immerse the temperature-sensitive cup of the thermostatic element in said oil, without there being any possibility of the oil mixing with the cooling liquid. In particular, the piston of the thermostatic element is secured to two shutters that are provided respectively to regulate the flows of the hot and cold cooling liquids entering the valve. The corresponding arrangements require numerous individual parts, thereby increasing the cost and the size of the valve, complicating assembly thereof, and also limiting service life because of the risks of leaks and of mechanical malfunctions.

The object of the present invention is to remedy those drawbacks by proposing a thermostatic element that limits the size of a thermostatic valve incorporating the element, that improves the reliability of the valve, and that makes the valve easier to assemble.

For this purpose, the invention provides a thermostatic element as defined in claim 1, and a thermostatic valve for regulating a fluid, in particular a cooling liquid, as defined in claim 5.

In the invention, because the sheath of the thermostatic element has a flow passage, it channels the fluid entering or leaving the valve housing via the first access to a zone for controlling the flow of said fluid towards or away from the second access by means of the first shutter. By incorporating this fluid passage inside the piston-guiding sheath, it is possible to reduce the axial size of the valve between the two fluid accesses. In addition, since the sheath is permanently secured to the cup of the thermostatic element, the valve is easier to assemble since this permanent connection is advantageously established outside the valve housing, as is indeed is the connection between the first shutter and the piston of the thermostatic element, and then the thermostatic element is fitted as a single unit in the valve housing. No additional part, such as an axial extender for the piston, needs to be fitted inside the fluid flow chamber between the first access and the shutter. In addition, since the zone in which the fluid flow is shut by the first shutter is provided at one of the ends of the passage defined by the sheath, whereas the sheath also serves to determine the relative position of the piston by guiding its movement in translation, the corresponding shutting action is effective and reliable, even in a difficult environment, e.g. one subjected to high operating temperatures and to mechanical vibration. The service life of the valve of the invention is thus remarkable. Finally, the cost and the number of parts constituting the thermostatic element and the valve of the invention are reduced compared with the prior art.

Advantageous characteristics of this thermostatic element and/of of this valve taken individually or in any technically feasible combination are specified in claims 2 to 4 and 6 to 11.

The invention also provides a cooling liquid flow circuit, in particular for a cooling liquid for an engine, the circuit being associated with a heat exchanger having the cooling liquid and a reference liquid passing therethrough, in particular having oil of a gearbox associated with the engine passing therethrough, said circuit being as defined in claim 12.

The invention can be better understood on reading the following description given purely by way of example and made with reference to the drawings, in which:

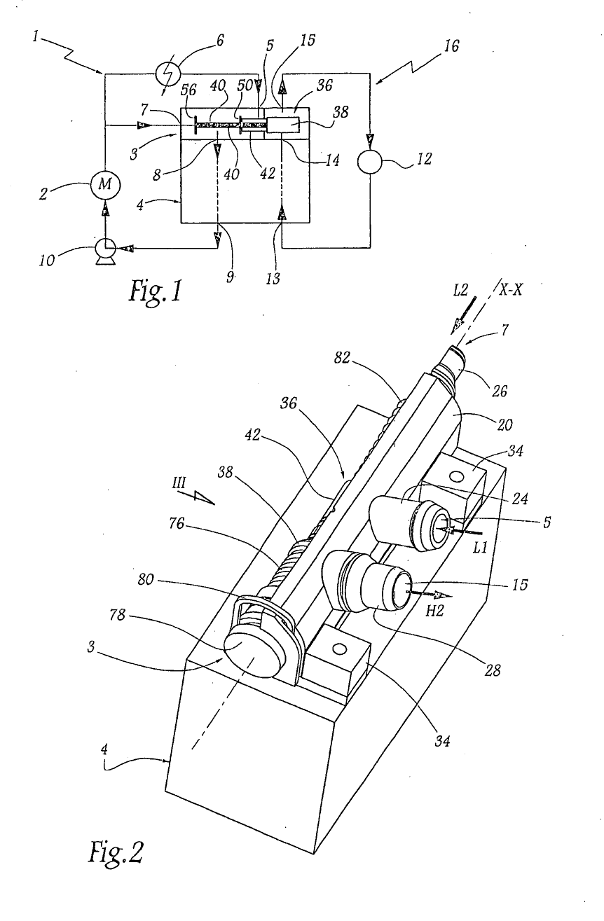

FIG. 1 is a schematic of a cooling fluid flow circuit fitted with a thermostatic valve in accordance with the invention and with a heat exchanger associated with the valve;

FIG. 2 is a perspective view of the valve and the heat exchanger fitted to the FIG. 1 circuit, a portion of the housing of the valve being omitted from the drawing;

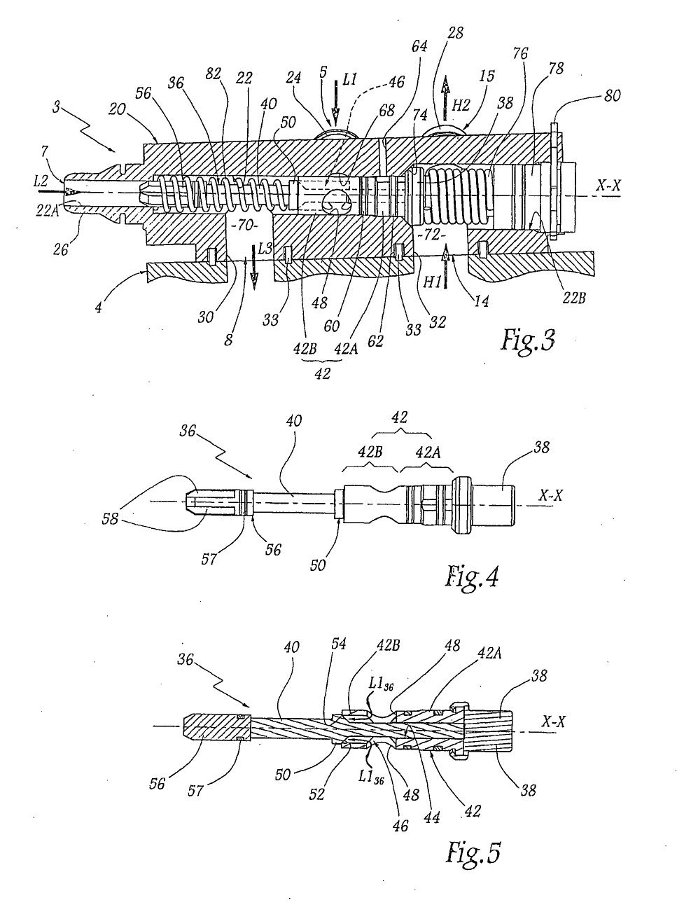

FIG. 3 is an elevation view looking along arrow III of FIG. 2, corresponding substantially to a longitudinal section of the valve housing;

FIG. 4 is an elevation view of a thermostatic element shown on its own, forming part of the valve of FIGS. 1 to 3; and

FIG. 5 is a longitudinal section of the thermostatic element of FIG. 4.

FIG. 1 shows a circuit 1 for circulating a cooling liquid for an engine 2, in particular a combustion engine for a motor vehicle. The circuit 1 has a thermostatic valve 3 and a heat exchanger 4 that are functionally associated with each other, as described in detail below.

Within the circuit 1, the cooling liquid feeds the valve 3 via two distinct inlets, namely a first inlet 5 fed with liquid coming from a radiator 6 suitable for lowering the temperature of the liquid coming from the engine 2 and passing therethrough, by heat exchange with the outside air, and a second inlet 7 fed with liquid coming directly from the engine 2, without the heat exchanger being interposed. In operation, it should understood that the temperature of the liquid admitted via the inlet 5 is lower than the temperature of the liquid admitted via the inlet 7, providing the flow rate through these inlets are not zero. The cooling liquid is designed to be discharged from the valve 3 via an outlet 8 feeding the heat exchanger 4, with the liquid exiting therefrom via an outlet 9 connected to a pump 10 for driving the liquid around the circuit 1, with the delivery from the pump being sent to the engine 2.

In the heat exchanger 4, the cooling liquid passing between the outlets 8 and 9 exchanges heat with the oil of a gearbox 12. The oil coming from the gearbox is fed in succession to the heat exchanger via an inlet 13 and to the valve 3 via an inlet 14. The oil is discharged from the valve via an outlet 15 that is connected to the gearbox 12. The oil from the gearbox thus flows around its own circuit 16 that is distinct from the cooling liquid circuit 1, in the sense that these two fluids do not mix.

The thermostatic valve 3 is shown in greater detail in FIGS. 2 and 3. This valve has a rigid outer housing 20, made in particular out of plastics material, and having an internal empty space 22 defined therein that is generally tubular in shape, being centered on a longitudinal axis X-X lying in the section plane of FIG. 3. Ignoring the other components of the valve 3, the space 22 is open to the outside via both of its axial ends, defining respective cylindrical orifices 22A and 22B that are centered on the axis X-X. The space 22 also opens to the outside via inlets 5, 7, and 14, and via outlets 8 and 15. In practice, the cooling liquid inlets 5 and 7, and the oil outlet 15 are in the form of respective tubes 24, 26, and 28 suitable for being connected to connection pipes forming parts of the circuits 1 and 16. The tubes 24 and 28 project from the housing 20 in a direction that is substantially radial relative of the axis X-X, while the tube 26 is centered on said axis, defining internally the end orifice 22A. The cooling liquid outlet 8 and the oil inlet 14 are respectively in the form of cylindrical bore-shaped orifices 30 and 32 extending from the space 22, radially relative to the axis X-X. When the housing 20 is assembled to the heat exchanger 4, the orifices 30 and 32 are in direct fluid-flow connection with corresponding orifices provided in the heat exchanger housing, as shown in FIG. 3. The outlet from each orifice 30, 32 is surrounded by a gasket 33 that is interposed between the valve housing 20 and the housing of the heat exchanger 4, it being observed that the valve housing is provided with tabs 34 (FIG. 2) for fastening it mechanically to the heat exchanger.

Going axially along the space 22 from its end orifice 22A, there are to be found in succession: the tube 26 of the inlet 7; the orifice 30 of the outlet 8; the tube 24 of the inlet 5; and substantially at the same axial position, both the tube 28 of the outlet 15 and the orifice 32 of the inlet 14.

The valve 3 includes a thermostatic element 36 shown alone in FIGS. 4 and 5, which element is designed to be arranged inside the space 22 when the valve is in the assembled configuration. This element 36 essentially comprises:
a temperature-sensitive cup 38 centered on the axis X-X when the valve 3 is assembled and filled with a thermodilatable material (i.e. a material that expands on being heated) such as a wax;
a piston 40 centered on the axis X-X when the valve is assembled and suitable for moving in translation along said axis relative to the cup 38 under the effect of the expansion of the thermodilatable material; and
an elongate sheath 42 centered on the axis X-X when the valve is assembled, suitable for guiding the piston 40 in sliding during its movement in translation, and securely fastened to the cup 38.

As shown in greater detail in FIGS. 4 and 5, the sheath 42 defines along its entire length an internal bore 44 centered on the axis X-X and within which the piston 40 extends lengthwise. More precisely, in the portion 42A of the sheath facing towards the cup 38, the corresponding portion of the bore 44 presents a cross-section that is substantially complementary to the one of the piston 40, so as to guide the piston effectively during its movement in translation, keeping it centered on the axis X-X. The free end of this portion of the sheath 42A is securely held stationary relative to the cup 38, e.g. by being crimped via an end collar forming part of the cup.

In the portion 42B of the sheath 42 remote from the cup 38, the corresponding portion of the bore 44 presents a transverse size that is greater than that of the piston 40, such that an empty volume 46 (FIG. 5) is defined radially between the outside surface of the piston and the inside surface of the sheath portion 42B. This empty volume 46 that is of generally annular shape centered on the axis X-X extends axially between the two axial ends of the sheath portion 42B. At the end facing towards the cup 38, i.e. the end formed integrally with the sheath portion 42A, the volume 46 communicates with the outside via two diametrically-opposite openings 48 on either side of the axis X-X, passing radially through the wall of the sheath. At the opposite end, the volume 46 opens out axially to the outside, receiving internally a shutter 50 secured to the piston 40. In the example shown in the figures, the shutter is made integrally with the main portion of the piston and forms a frustoconical surface 52 centered on the axis X-X and converging towards the cup 38. Depending on the position of the piston relative to the sheath, this surface 52 serves to bear in leaktight manner against a seat 54 defined internally by the corresponding end of the volume 46.

Advantageously, the piston 40 is rigidly provided with another shutter 56 located at its end remote from the cup 38. This shutter 56 is in the form of a generally cylindrical body centered on the axis X-X with the end portion thereof that faces towards the cup being provided on the outside with a sealing ring 57, while its opposite end portion has axial grooves 58 formed therein giving this portion a cross-section that is generally cross-shaped.

The shutter 56 is optional since the invention is applicable both to a valve of the type having three orifices and two positions, and to a valve of the type having two orifices and two positions.

In the assembled state of the thermostatic valve 3, as shown in FIGS. 2 and 3, the thermostatic element 36 is arranged inside the valve housing 20 so that its sheath 42 subdivides the internal space 22 in leaktight manner into two portions located successively along the axis X-X, and respectively having flowing therein the cooling liquid of the circuit 1 and the oil of the circuit 16 where they pass through the valve housing. For this purpose, the wall of the housing defining the space 22 is caused to fit in its portion situated axially between the inlet 5 and the outlet 15 in substantially complementary manner against the sheath housing 42A so that this sheath portion is received in leaktight manner, with interposed sealing means in the form of two distinct gaskets 60 and 62 following each other along the axis X-X. The sheath portion 42A and the gaskets 60 and 62 thus isolate the portion of the space 22 in which the cooling liquid flows from the portion of the space in which the oil flows. The use of these two gaskets limits any risk of these two fluids accidentally mixing together, given that an external bleed orifice 64 is defined by the valve body so as to open out between these two gaskets. As a result, if the sealing provided by one or the other of the gaskets 60 and 62 becomes compromised, the cooling liquid or the oil going axially past the faulty gasket is discharged via the orifice 64 out from the valve housing and without becoming mixed with the other fluid.

At the end of the valve housing 20 that is associated with the cooling liquid, the corresponding portion of the space 22 receives the sheath portion 42B and a portion of the piston 40: the sheath portion 42B is received as a substantially snug fit in the valve housing, axially level with the inlet 5, while the end shutter 56 is arranged level with the inlet 7, being received at least in part as a substantially snug fit in the end orifice 22A.

In operation, when the inlet 5 is fed with cooling liquid, as represented by arrow L1 in FIGS. 2 and 3, this liquid penetrates into the valve housing via the tube 24 and reaches the sheath portion 42B. Since the openings 48 are situated axially level with the outlet of the tube 24 into the space 22, the liquid is admitted radially into the volume 46, via its openings 48, and then flows axially within the sheath portion 42B towards the seat 54, as represented by arrows L1₃₆ shown in FIG. 5 only. The volume 46 thus forms a fluid flow passage within the sheath. If the shutter 50 is axially spaced apart from the seat 54 (configuration not shown), the fluid then flows axially in a partially empty portion of the space 22 forming a chamber 70 in which the fluid thus flows within the valve housing 20 to the orifice 30 of the outlet 8.

In order to facilitate and increase the flow of fluid between the outlet of the tube 24 into the space 22 and the radial opening 48, a groove 68 is advantageously formed in a circumferential direction about the axis X-X within the valve housing 20, axially at the level of the first inlet 5. This groove 68 need not necessarily extend around the entire inside periphery of the housing, but should extend over a fraction that is sufficient to open out into both openings 48 regardless of the angular position, about the axis X-X, of the sheath 42 in the space 22.

Similarly, in operation, when the inlet 7 is fed with cooling liquid, as represented by arrow L2, this liquid penetrates into the valve housing 20 via the tube 26 and reaches the shutter 56. The liquid flows axially along the grooves 58 and, if the shutter 56 is sufficiently disengaged from the orifice 22A to enable the gasket 57 to be located outside said orifice (configuration not shown), the liquid then goes round the gasket and flows to the chamber 70, with the shutter 76 then acting as a slide type shutter.

It will be understood that when the chamber 70 is fed both with liquid coming from the inlet 5 and with liquid coming from the inlet 7, these two liquids mix in the chamber 70 prior to being discharged via the outlet 8 as represented by arrow L3.

At the end of the valve housing that is associated with oil, the corresponding portion of the internal space 22 forms an oil flow channel 72 between the inlet 14 and the outlet 15, radially connecting the orifice 32 with the tube 28. The corresponding admission and discharge of oil are represented by arrows H1 and H2. The cup 38 of the thermostatic element 36 is arranged across the channel 72, being immersed in the oil that flows therein. The cup 38 is held stationary in the valve housing, being pressed axially to bear against a corresponding shoulder 74 inside the housing by a compression spring 76. One of the ends of this spring surrounds a portion of cup 38, while its opposite end bears against a stopper 78 held at the axial end of the valve housing 20 that is remote from the tube 26. This stopper is in the form of a generally cylindrical part that is substantially complementary to the end orifice 22B of the space 22. When the valve is in the assembled state, the stopper 78 closes the orifice 22B, with a sealing gasket being radially interposed therebetween. A clip 80 presents the stopper from moving relative to the valve housing along the axis X-X.

In order to assemble the thermostatic valve 3, the end orifice 22B is used to insert the thermostatic element 36 and the spring 76 into the internal space 22. More precisely, the thermostatic element, in particular with its sheath 42, is initially prepared and then inserted axially into the space 22 via the orifice 22B until the cup 38 comes into abutment against the shoulder 74, the shoulder advantageously converging towards the axis X-X in the insertion direction in which the thermostatic element is inserted into the valve housing, thereby enabling said element to be centered automatically on the axis X-X. When the cup reaches the vicinity of the shoulder 78, the free end of the shutter 56 is inserted axially into the end orifice 22A. This end of the shutter is advantageously chamfered so as to facilitate insertion thereof. Thus, by applying a single generally axial movement, the thermostatic element 36 is inserted quickly and easily into the inside of the valve housing 20, as far as its final assembly position, in which position it is held by the spring 76 once the stopper 78 is itself held by the clip 80 in the orifice 22B.

In operation of the circuits 1 and 16, oil sweeps permanently over the cup 38, such that the oil constitutes a reference liquid in the sense that it is the temperature of the oil that controls the regulation of the cooling liquid by the valve 3. For example, assuming that the valve is initially in its FIG. 3 configuration and that the temperature of the oil increases until it exceeds a predetermined threshold value, then the piston 40 moves axially (to the left in FIGS. 3 to 5) under the effect of the expansion of the material contained in the cup 38, the piston being guided by the sheath portion 42A. The shutter 50 is moved correspondingly in translation, thereby disengaging the seat 54: the cooling liquid admitted into the inlet 5, i.e. the liquid coming from the engine 2 after passing through the cooling radiator 6, then flows between this inlet 5 and the chamber 70 successively via the grooves 68, the openings 48, the passage formed by the volume 46, and the seat 54. The liquid then mixes with the liquid admitted into the chamber by the shutter 56, via its grooves 58 and going round its gasket 57, i.e. it mixes with the fluid coming directly from the engine 2 and thus presenting a temperature higher than the temperature of the fluid coming from the radiator 6. These two cooling fluids mix in the chamber 70, from which they are discharged via the outlet 8 at an intermediate temperature. By heat exchange in the heat exchanger 4, the oil of the circuit 16 cools down while the cooling liquid heats up, prior to being returned to the engine by the pump 10.

The cooling of the oil consequently causes the material contained in the cup 38 to retract and the piston retracts into the cup, being returned by a compression spring 82 interposed between the shutter 50 and a shoulder defined by the housing at the outlet from the orifice 22A into the remainder of the space 22.

Thus, depending on the cooling requirements of the oil, the quantity of cold cooling liquid, i.e. liquid coming from the radiator 6, is regulated, it being understood that the inlet 7 may be shut completely by the shutter 56 when the piston 50 is deployed far enough under the effect of a large amount of expansion of the material contained in the cup 38, associated with the temperature of the oil flowing in the channel 72 being high.

Various arrangements and variants of the thermostatic valve 3 and of the cooling liquid circuit 1 can be envisaged. As examples:
the stationary connection between each shutter 50, 56 and the piston 40 may present a variety of shapes, providing the movements in translation of the piston are transmitted to the shutters;
the flow direction of the fluid through the accesses 5, 7, 8, 14, and 15 defined by the valve 3 may be reversed, in particular depending on whether or not the valve is associated with a heat exchanger such as the heat exchanger 4, and/or in order to adapt to different circuit architectures; thus, the cooling liquid may be admitted into the valve via a single inlet access and may leave it via the other two accesses; and
the invention is applicable to valves of the 3-position and 2-orifice type or to valves of the 2-position and 2-orifice type, in which case the shutter 56 can be omitted.

1-12. (canceled)

13. A thermostatic element, comprising a cup filled with a thermodilatable material, a piston that is movable in translation along an axis relative to the cup under the effect of the thermodilatable material expanding, and a sheath for guiding movement of the piston in translation, which sheath is held stationary relative to the cup and defines internally a fluid flow passage, having a first end facing towards the cup, which first end is open transversely to the outside of the sheath and is adapted to be connected to a fluid access, while a second end of the fluid flow passage, remote from the cup, is open axially to the outside of the sheath and is shuttable by a first shutter carried by the piston.

14. A thermostatic element according to claim 13, wherein the second end of the fluid flow passage defines a seat against which the first shutter can bear in leaktight manner.

15. A thermostatic element according to claim 13, wherein the first end of the fluid flow passage opens out radially to the outside of the sheath.

16. A thermostatic element according to claim 13, wherein the piston is fed axially through the fluid flow passage.

17. A thermostatic valve for regulating a fluid, in particular a cooling fluid, the valve comprising a thermostatic element according to claim 1 and a housing defining two fluid accesses opening out, at successive positions along the axis associated with the thermostatic element, into a fluid flow chamber between the two accesses, wherein the thermostatic element is arranged in the housing in such a manner that the cup is held stationary at one axial end of the fluid flow chamber and the first end of the fluid flow passage opens out into a first one of the two fluid accesses that is situated axially closer to the cup, while the second end of said fluid flow passage opens out into the chamber.

18. A valve according to claim 17, wherein at the first end of the fluid flow passage, the sheath defines at least one transverse opening putting the fluid flow passage into fluid-flow communication with a peripheral groove formed in a generally circumferential direction about the axis in the housing at the first fluid access.

19. A valve according to claim 17, wherein the sheath is provided on the outside with sealing means suitable for closing in leaktight manner the axial end of the fluid flow chamber when the cup is held stationary.

20. A valve according to claim 19, wherein the sealing means include at least two sealing elements disposed in succession along the axis, and wherein the housing defines a bleed orifice leading to the outside opening out between these two sealing elements.

21. A valve according to claim 17, wherein the housing defines a third fluid access opening out into the fluid flow chamber, the second fluid access being situated axially between the first and third fluid accesses, and wherein the valve includes a second shutter carried by the piston and adapted to control the flow of fluid between the second and third fluid accesses.

22. A valve according to claim 18, wherein the housing also defines a flow channel through the housing for another fluid other than the fluid regulated by the valve, the cup being disposed at least in part in said flow channel, while the sheath separates said flow channel in leaktight manner from the fluid flow chamber.

23. A valve according to claim 22, wherein the portion of the flow channel, in which the cup is, extends axially, away from the chamber, by a through orifice defined by the housing and adapted firstly to allow the thermostatic element to pass axially from outside the housing into the fluid flow chamber during assembly of the valve, and secondly to receive a leaktight closure stopper that is secured to the housing.

24. A cooling liquid flow circuit, in particular for a cooling liquid for an engine, the circuit being associated with a heat exchanger through which said cooling liquid passes and through which a reference liquid passes, in particular oil from a gearbox associated with the engine, the circuit including a thermostatic valve in accordance with claim 9, wherein the housing also defines a flow channel through the housing for the reference liquid, the cup being disposed at least in part in said flow channel, while the sheath separates said flow channel in leaktight manner from the fluid flow chamber, and wherein [symbol]
the first fluid access is fed by the cooling liquid at a first temperature; [symbol]
the third fluid access is fed by the cooling liquid at a second temperature higher than the first temperature; [symbol]
the second fluid access feeds an inlet of the heat exchanger with the cooling liquid at a temperature lying between the first and second temperatures; and [symbol]
the flow channel is fed with the reference liquid by an outlet of the heat exchanger.
